(19) United States
(12) Patent Application Publication
(10) Pub. No.: US 2017/0349162 A1
(43) Pub. Date: Dec. 7, 2017

(54) SYSTEM AND METHOD FOR CONTROLLING ENGINE IN HYBRID VEHICLE

(71) Applicant: Hyundai Motor Company, Seoul (KR)

(72) Inventor: Gyu Hong Kim, Suwon (KR)

(21) Appl. No.: 15/336,741

(22) Filed: Oct. 27, 2016

(30) Foreign Application Priority Data
Jun. 7, 2016 (KR) 10-2016-0070264

(51) Int. Cl. B60W 20/13; B60L 11/18

(52) U.S. Cl. CPC B60W 20/13; B60L 11/1861

(57) ABSTRACT

A system and method are provided for controlling an engine in a hybrid vehicle by varying the operating point of the engine using a table in which SOC compensation values of a battery corresponding to deterioration degrees of the battery are recorded, to operate the engine at optimal timing regardless of the deterioration degrees of the battery and allow sufficient catalyst warm-up time. The method includes storing a table in which SOC compensation values of a battery corresponding to deterioration degrees of the battery are recorded and calculating a deterioration degree of the battery. An SOC compensation value of the battery corresponding to the calculated deterioration degree in the table is detected. Further, the method includes compensating for an SOC of the battery using the detected SOC compensation value and setting an operating point of the engine based on the compensated SOC of the battery.

### CROSS-REFERENCE TO RELATED APPLICATION

This application is based on and claims the benefit of priority to Korean Patent Application No. 10-2016-0070264, filed on Jun. 7, 2016, in the Korean Intellectual Property Office, the disclosure of which is incorporated herein in its entirety by reference.

### BACKGROUND

### Technical Field

The present disclosure relates to a system and method for controlling an engine in a hybrid vehicle and, more particularly, to a technology for varying an engine operating point in a hybrid vehicle having an engine and an electric motor by considering the deterioration degree of a battery.

### Related Art

In general, a hybrid vehicle is driven using two or more types of power generated by an efficient combination of different power sources. A hybrid vehicle commonly uses an engine that generates driving power through the combustion of a fuel (generally, fossil fuel such as gasoline) and an electric motor that is driven by power of a battery to generate driving power. Hybrid vehicles may have various configurations using an engine and an electric motor as power sources. For example, a parallel hybrid vehicle uses an engine that directly delivers mechanical power to the wheels, while receiving an assist from an electric motor that is driven by power of a battery when necessary, and a series hybrid vehicle converts mechanical power from an engine into electric power using a generator to drive an electric motor or charge a battery. In general, a parallel hybrid vehicle is advantageous for high-speed driving or long-distance driving, and a series hybrid vehicle is advantageous for city driving or short-distance driving.

Recently, a plug-in hybrid electric vehicle (PHEV) is being developed to increase the capacity of a battery to be greater than that of a conventional hybrid vehicle and charge the battery with power from an external power source, to operate PHEV in an electric vehicle (EV) mode for short-distance driving and in a hybrid electric vehicle (HEV) mode when the battery is depleted. In other words, a PHEV shares the characteristics of a conventional hybrid vehicle, having an internal combustion engine operating by gasoline and a battery engine to be driven using one or both engines, but is equipped with a large-capacity high-voltage battery to be charged with external electricity.

Such a PHEV may be driven in the HEV mode by operating an engine when power required by a driver is greater than the maximum output power of the motor and battery or a state of charge (SOC) of the battery is less than or equal to a reference level (e.g., about 20%). Further, the PHEV may be driven in the EV mode without operating the engine, when the required power is within the output of the motor and battery and the battery is charged with power from an external power source before being discharged. Meanwhile, the PHEV uses a catalyst for emission reduction. Since a temperature (e.g. about 600° C.) at which the catalyst is activated is significantly greater than ambient temperature, the engine is operated to increase the catalyst temperature and activate the catalyst. To reduce kinetic energy and increase heat energy in energy generated by the engine, an engine control unit (ECU) sufficiently decreases an ignition angle.

According to a method for controlling an engine of a conventional PHEV, the PHEV is driven in the HEV mode when the SOC of the battery is a reference level (e.g., about 20%), without considering the deterioration degree of the battery, and thus, it may be difficult to comply with emission standards. In other words, when the deterioration of the battery occurs, the amount of power corresponding to the reference level is reduced and the operating point of the engine is changed, and thus, it may be difficult to allow a sufficient catalyst warm-up time (e.g., about 30 seconds) and comply with emission standards.

### SUMMARY

The present disclosure provides a system and a method for controlling an engine in a hybrid vehicle by varying the operating point of the engine based on a table in which SOC compensation values of a battery corresponding to deterioration degrees of the battery are recorded, to operate the engine at optimal timing regardless of the deterioration degrees of the battery and allow sufficient catalyst warm-up time.

The objects of the present disclosure are not limited to the foregoing objects and any other objects and advantages not mentioned herein will be clearly understood from the following description. The present inventive concept will be more clearly understood from exemplary embodiments of the present disclosure. In addition, it will be apparent that the objects and advantages of the present disclosure can be achieved by elements and features claimed in the claims and a combination thereof.

According to an aspect of the present disclosure, a method for controlling an engine in a hybrid vehicle may include: storing a table in which SOC compensation values of a battery corresponding to deterioration degrees of the battery are recorded; calculating a deterioration degree of the battery; detecting an SOC compensation value of the battery that corresponds to the calculated deterioration degree of the battery in the table; compensating for an SOC of the battery using the detected SOC compensation value; and setting an operating point of the engine based on the compensated SOC of the battery.

According to another aspect of the present disclosure, a method for controlling an engine in a hybrid vehicle may include: calculating a deterioration degree of a battery; calculating an SOC compensation value of the battery that corresponds to the calculated deterioration degree of the battery; compensating for an SOC of the battery using the calculated SOC compensation value; and setting an operating point of the engine based on the compensated SOC of the battery.

### BRIEF DESCRIPTION OF THE DRAWINGS

The above and other objects, features, and advantages of the present disclosure will be more apparent from the following detailed description taken in conjunction with the accompanying drawings:

FIG. 1 illustrates the configuration of a hybrid system according to an exemplary embodiment of the present disclosure; and

FIG. 2 illustrates a flowchart of a method for controlling an engine in a hybrid vehicle, according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referral to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The above and other objects, features, and advantages of the present disclosure will be more clearly understood from the following detailed description taken in conjunction with the accompanying drawings so that those skilled in the art to which the present disclosure pertains can easily carry out technical ideas described herein. In addition, a detailed description of well-known techniques associated with the present disclosure will be ruled out in order not to unnecessarily obscure the gist of the present disclosure. Hereinafter, exemplary embodiments of the present disclosure will be described in detail with reference to the accompanying drawings.

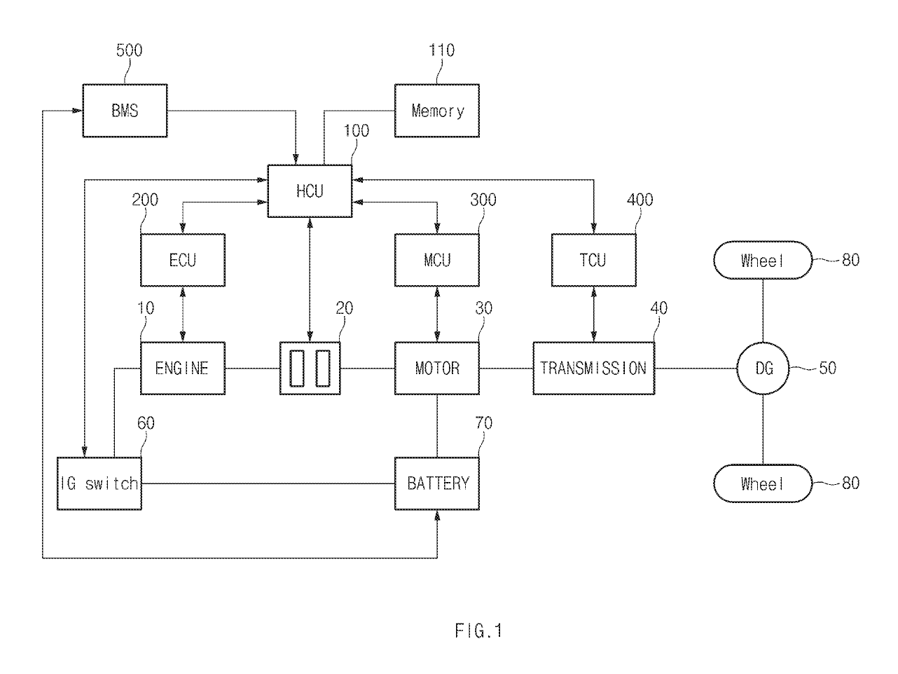

FIG. 1 illustrates the configuration of a hybrid system, to which the present inventive concept is applied. As illustrated in FIG. 1, a hybrid system, to which the present inventive concept is applied, may include an engine 10, an engine clutch 20, a motor 30, a transmission 40, a differential gear 50, an ignition switch 60, a battery 70, and wheels 80. Additionally, the system may include a controller configured to operate the other components of the system.

The engine clutch 20 may be configured to regulate power between the engine 10 and the motor 30. The ignition switch 60 may be configured to start the engine 10 or start the motor 30 through the battery 70 connected to the motor 30 and the battery 70 may be configured to supply voltage to the motor 30 in an EV driving mode. In addition, the hybrid system may include a hybrid control unit (HCU) 100, a non-volatile memory 110 connected to the HCU 100, an engine control unit (ECU) 200, a motor control unit (MCU) 300, a transmission control unit (TCU) 400, and a battery management system (BMS) 500. An overall controller may be configured to operate the various control units of the system.

Particularly, the ECU 200, the MCU 300, and the TCU 400 may be configured to execute the overall operations of the engine 10, the motor 30, and the transmission 40, respectively. The ECU 200 may be configured to operate the engine 10 based on a control signal applied by the HCU 100 via a network (e.g., a controller area network CAN). The MCU 300 may be configured to adjust output torque and speed of the motor 30 based on required output by converting direct current (DC) voltage of the battery 70 into three-phase alternating current (AC) voltage based on a control signal supplied from the HCU 100 via the network. In addition, the MCU 300 may be configured to rotate (e.g. crank) the engine by the motor 30 to start the engine according to control of the HCU 100.

Furthermore, the MCU 300 may include an inverter having a plurality of power switching elements. In particular, the power switching element may be any one of an insulated gate bipolar transistor (IGBT), a metal oxide semiconductor field effect transistor (MOSFET), and a transistor. The BMS 500 may be configured to manage a state of charge (SOC) of the battery 70 by detecting the current, voltage, temperature, and the like of each cell within an operating area of the battery 70, provide information regarding the battery 70 to the HCU 100 via the network, and adjust charging and discharging voltage of the battery 70 to prevent the battery from being over discharged (e.g., discharged beyond a particular level) to be less than or equal to a limit voltage or being overcharged to be greater than or equal to a limit voltage and avoid a reduction in the lifespan of the battery.

The HCU 100 is a high-level controller or an upper controller configured to execute the overall operations of the hybrid vehicle, and may be connected to all control units via the network to exchange information, and perform cooperative controls to adjust output torque of the engine 10 and the motor 30 and adjust a target gear ratio to continuously drive the vehicle. The non-volatile memory 110 is a type of memory that may retain stored data even when power is shut off and may be able to erase or remove data and input new data. The non-volatile memory 110 may be disposed inside of or extraneous to the HCU 100. The non-volatile memory 110 includes a flash memory, and an electrically erasable and programmable read only memory (EEPROM). In addition, the HCU 100 may be configured to calculate an engine revolutions per minute (RPM), an engine torque, an ignition angle, and the like, and transmit a command to the ECU 200 by a control signal.

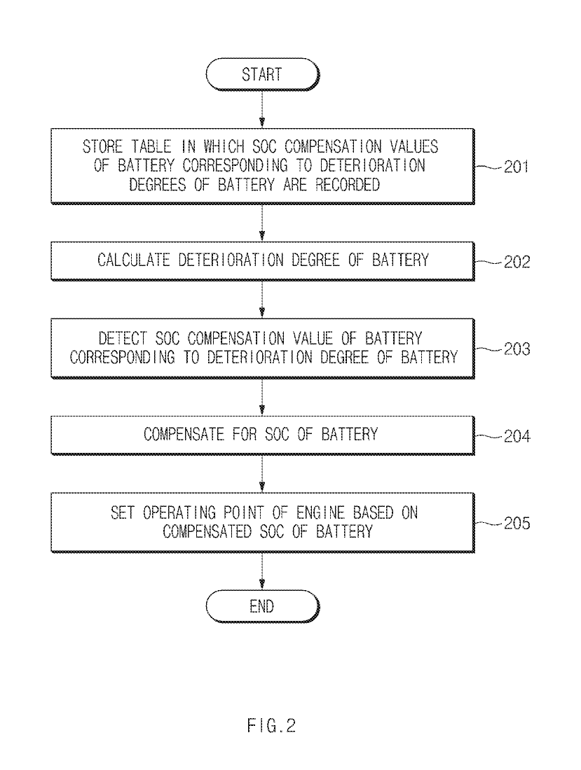

FIG. 2 illustrates a flowchart of a method for controlling an engine in a hybrid vehicle, according to an exemplary embodiment of the present disclosure. The memory 110 may be configured to store a table in which SOC compensation values of the battery 70 corresponding to deterioration degrees of the battery 70 are recorded, in operation 201. Such a table is illustrated by way of example as follows:

TABLE 1

| Deterioration | SOC |
|---|---|
| Degree of | Compensation |
| Battery (%) | Value (%) |
| 0 | 0 |
| . | . |
| . | . |
| . | . |
| 10 | 2.5 |
| . | . |
| . | . |
| . | . |
| 20 | 5 |

Table 1 shows three values as an example, and SOC compensation values corresponding to the deterioration degrees of the battery 70 between 0 and 20% may be derived from Table 1. For example, when the deterioration degree of the battery is 5%, a corresponding SOC compensation value is 1.25, and when the deterioration degree of the battery is 15%, a corresponding SOC compensation value is 3.75. In particular, the SOC compensation value may also be negative. In Table 1, the deterioration degrees of the battery range from 0 to 20%, and the corresponding SOC compensation values range from 0 to 5%. However, the above ranges are merely exemplary, and may be extended.

Further, the HCU 100 may be configured to calculate a deterioration degree D of the battery 70 in operation 202. For example, the deterioration degree D of the battery 70 may be calculated based on the following Equation 1:

$$D = \frac{{Ah}_{aged}}{{Ah}_{initial}} \times 100 \qquad Equation 1$$

wherein, Ah_{aged} refers to a current charge capacity and Ahᵢₙᵢₜᵢₐₗ refers to an initial charge capacity.

Thereafter, the HCU 100 may be configured to detect an SOC compensation value that corresponds to the calculated deterioration degree of the battery 70 based on the table in operation 203. Then, the HCU 100 may be configured to compensate for an SOC of the battery 70 by adding the detected SOC compensation value to the SOC of the battery 70 obtained from the BMS 500 in operation 204. Alternatively, the HCU 100 may also be configured to compensate for the SOC of the battery 70 by subtracting the detected SOC compensation value from the SOC of the battery 70 obtained from the BMS 500. The HCU 100 may be configured to set an operating point of the engine based on the compensated SOC of the battery 70 in operation 205. Then, the HCU 100 may be configured to operate the vehicle at the set operating point to thus operate the vehicle while increasing the lifespan of the battery.

By setting the engine operating point as described above, the ECU 200 under operation of the HCU 100 may allow sufficient catalyst warm-up time. For example, when the deterioration degree of the battery 70 is 0%, the ECU 200 may be configured to operate the engine when the SOC of the battery 70 is a reference value (e.g., about 20%); when the deterioration degree of the battery 70 is 10%, the ECU 200 may be configured to operate the engine when the SOC of the battery 70 is 22.5%; and when the deterioration degree of the battery 70 is 20%, the ECU 200 may be configured to operate the engine when the SOC of the battery 70 is 25%. The amount of power at the engine operating point may be the same in respective cases.

According to another exemplary embodiment of the present disclosure, the HCU 100 may be configured to directly calculate an SOC compensation value of the battery 70 that corresponds to the deterioration degree of the battery 70, without a table in which SOC compensation values of the battery 70 corresponding to deterioration degrees of the battery 70 are recorded. Particularly, the HCU 100 may be configured to calculate the SOC compensation value based on previous determination that when the deterioration degree of the battery 70 is 0%, the SOC compensation value of the battery 70 is also 0%, and when the deterioration degree of the battery 70 is 20%, the SOC compensation value of the battery 70 is 5%.

Meanwhile, the above-stated method according to the exemplary embodiments of the present disclosure may be written as a computer program. Codes and code segments constituting the program may easily be inferred by a computer programmer skilled in the art. The written program may be stored in a non-transitory computer-readable recording medium (an information storage medium) and be read and executed by a computer, thereby implementing the method according to the exemplary embodiments of the present disclosure. The recording medium includes all types of non-transitory computer-readable recording media.

As set forth above, the method for controlling an engine in a hybrid vehicle according to the exemplary embodiments of the present disclosure may vary the operating point of the engine using a table in which the SOC compensation values of the battery corresponding to the deterioration degrees of the battery are recorded, thereby operating the engine at optimal timing regardless of the deterioration degrees of the battery to allow sufficient catalyst warm-up time. In addition, by operating the engine at optimal timing, regardless of the deterioration degrees of the battery, to allow the sufficient catalyst warm-up time, the hybrid vehicle may comply with emission standards.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for controlling an engine in a hybrid vehicle, comprising:
storing, by a controller, a table in which state of charge (SOC) compensation values of a battery corresponding to deterioration degrees of the battery are recorded;
calculating, by the controller, a deterioration degree of the battery;
detecting, by the controller, an SOC compensation value of the battery corresponding to the calculated deterioration degree of the battery in the table;
compensating, by the controller, for an SOC of the battery using the detected SOC compensation value; and
setting, by the controller, an operating point of the engine based on the compensated SOC of the battery.

2. The method according to claim 1, further comprising:
operating, by the controller, the engine at the set operating point to allow a predetermined catalyst warm-up time.

3. The method according to claim 1, wherein the SOC of the battery is compensated for by adding the SOC compensation value to the SOC of the battery.

4. The method according to claim 1, wherein the SOC of the battery is compensated for by subtracting the SOC compensation value from the SOC of the battery.

5. The method according to claim 1, wherein the hybrid vehicle is a plug-in hybrid electric vehicle (PHEV).

6. A method for controlling an engine in a hybrid vehicle, comprising:
calculating, by a hybrid control unit (HCU), a deterioration degree of a battery;
calculating, by the HCU, a state of charge (SOC) compensation value of the battery corresponding to the calculated deterioration degree of the battery;
compensating, by the HCU, for an SOC of the battery using the calculated SOC compensation value; and
setting, by the HCU, an operating point of the engine based on the compensated SOC of the battery.

7. The method according to claim 6, further comprising:
operating, by the HCU, the engine at the set operating point to allow a predetermined catalyst warm-up time.

8. The method according to claim 6, wherein the SOC of the battery is compensated for by adding the SOC compensation value to the SOC of the battery.

9. The method according to claim 6, wherein the SOC of the battery is compensated for by subtracting the SOC compensation value from the SOC of the battery.

10. The method according to claim 6, wherein the hybrid vehicle is a plug-in hybrid electric vehicle (PHEV).

11. A system for controlling an engine in a hybrid vehicle, comprising:
a memory configured to store a table in which state of charge (SOC) compensation values of a battery corresponding to deterioration degrees of the battery are recorded; and
a hybrid control unit (HCU) configured to:
calculate a deterioration degree of the battery;
detect an SOC compensation value of the battery corresponding to the calculated deterioration degree of the battery in the table;
compensate for an SOC of the battery using the detected SOC compensation value; and
set an operating point of the engine based on the compensated SOC of the battery.

12. The system according to claim 11, wherein the HCU is further configured to operate the engine at the set operating point to allow a predetermined catalyst warm-up time.

13. The system according to claim 11, wherein the SOC of the battery is compensated for by adding the SOC compensation value to the SOC of the battery.

14. The system according to claim 11, wherein the SOC of the battery is compensated for by subtracting the SOC compensation value from the SOC of the battery.

15. The system according to claim 11, wherein the hybrid vehicle is a plug-in hybrid electric vehicle (PHEV).
